(19) United States
(12) Patent Application Publication
(10) Pub. No.: US 2009/0000913 A1
(43) Pub. Date: Jan. 1, 2009

(54) Preform Unscrambling and Orienting Apparatus

(76) Inventor: Mario Lanfranchi, Collecchio (IT)

Correspondence Address: YOUNG & THOMPSON, 209 Madison Street, Suite 500, ALEXANDRIA, VA, 22314, US

(21) Appl. No.: 12/162,359

(22) PCT Filed: Jan. 23, 2007
(86) PCT No.: PCT/EP07/00533

§ 371 Date: Jul. 28, 2008

(30) Foreign Application Priority Data
Jan. 26, 2006 (IT) PR2006A000004

(51) Int. Cl. B65G 47/28

(52) U.S. Cl. 198/452

(57) ABSTRACT

An apparatus (1) for unscrambling and rienting plastic performs introduced in bulk in such apparatus (1), to arrange performs in an essentially upright position, wherein a conveyor (7) is placed at the end of a slit (6) within which the performs are rotated. Such conveyor (7) is placed at the same level as the preform exiting from the slit (6).

The present invention relates to an apparatus for orienting and unscrambling plastic bottle preforms, also known in the art as parisons.

The prior art is described in WO2004/069700, which discloses and provides a device for orienting bottle preforms that are designed to pass through a blow molding machine and thereby form plastic containers.

This apparatus is a movable inclined system having a plurality of pockets arranged along the periphery of the machine, each being adapted to receive one of the preforms loaded therein in bulk; by rotation of the movable system, each pocket carries the preform onto a first widened opening or slit, which is smaller than the diameter of the collar of the preform but large enough to allow the latter to rotate and take an upright position; then, the preform is moved into a second widened opening, or slit, larger than the former and than the collar diameter, so that such preform can freely slide below the movable system.

Below such system the apparatus has an inclined ramp for guiding the fallen preform and bring it to the blow molding machine.

Drawbacks are found in the prior art at the time of passage from the movable system to the inclined ramp, when the preform may at times not be perfectly aligned with the inclined ramp and at best come out of it or become stuck between such means and cause the whole blow molding line to jam.

The object of this invention is to obviate the above drawbacks by optimizing the preform exit area to avoid jamming, time delays and prevent the preforms from coming out of their pockets.

These objects and advantages are achieved by the unscrambling and orienting apparatus according to this invention, which is characterized by the annexed claims.

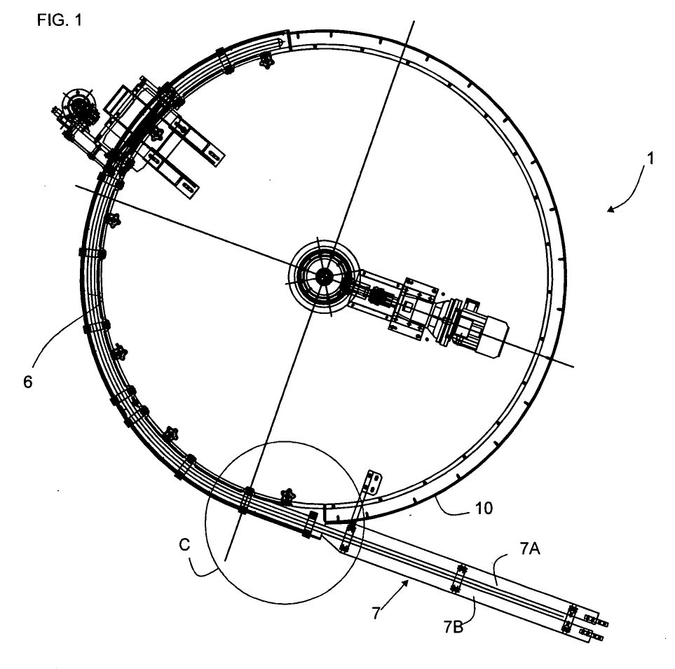

These and other features will be more apparent from the following description of a few embodiments, which are shown by way of example and without limitation in the accompanying drawings, in which: P FIG. 1 is a top view of a preform unscrambling and selecting machine,

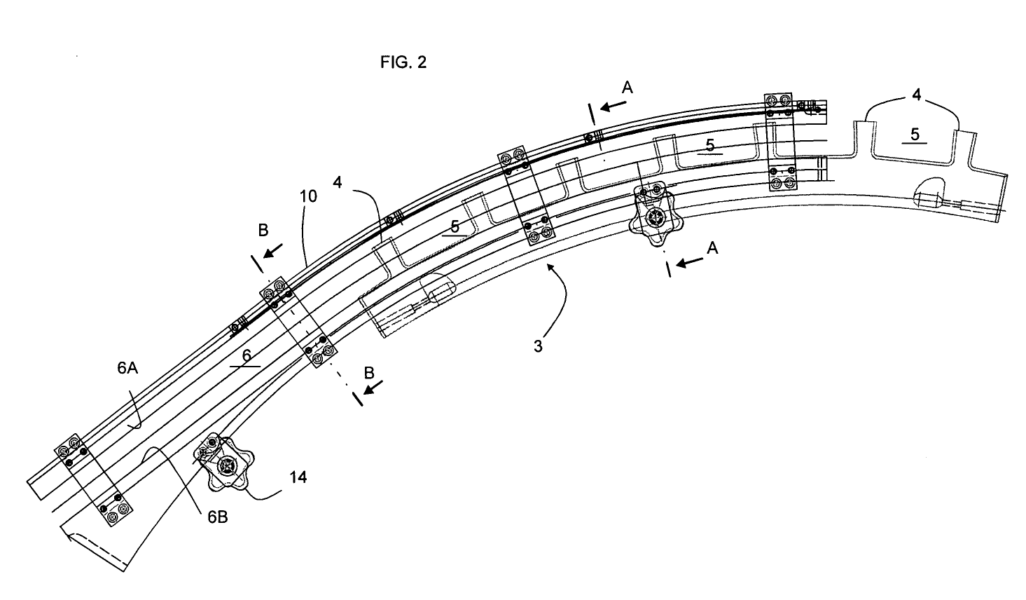

FIG. 2 is a detail view of the exit area, designated by C, of FIG. 1,

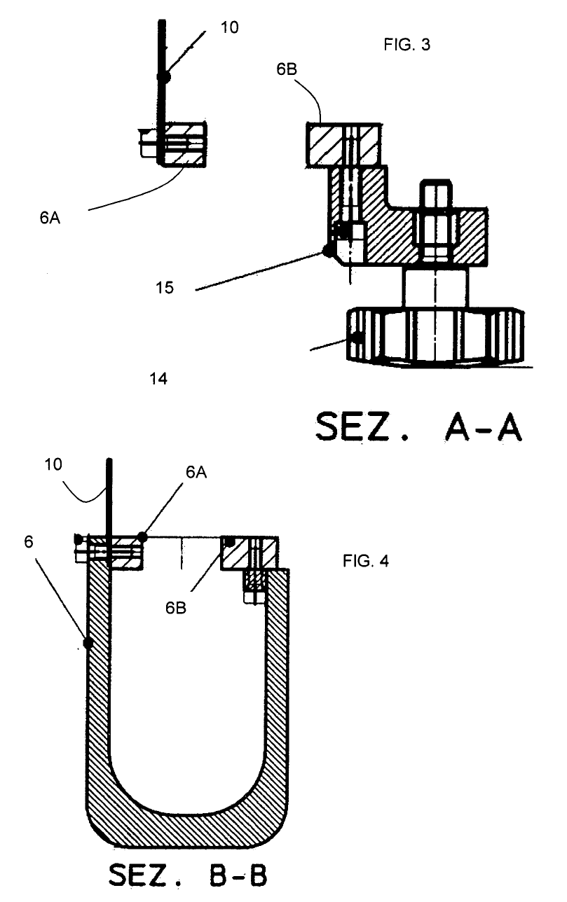

FIG. 3 shows an A-A section of the machine,

FIG. 4 shows a B-B section of the machine.

Referring to FIG. 1, numeral 1 generally designates an apparatus 1 for unscrambling and orienting plastic preforms.

This apparatus 1, as is known in the above mentioned prior art, comprises a circular hopper (or container), designated by numeral 2, having a ring 3 therein, concentric with such hopper 2, with a series of indentations 4 adapted to define a plurality of pockets or housings 5, which are in turn adapted to contain one preform at a time in an essentially horizontal position.

Therefore, during rotation each housing 5 carries one preform.

The hopper is typically inclined so that bulk preforms lie in the bottom portion and, as they move into the housings 5, they are carried to an appropriate level by such housings 5.

This provides unscrambling of the preforms introduced in bulk in such apparatus 1, and orientation thereof, for arranging such preforms in an essentially upright position.

The preform from which the plastic container, generally a bottle, is to be formed has a cylindrical body, a collar of larger diameter than the body, and usually a neck with a screw thread corresponding to that of the final container (on which a sealing cap will be tightened).

An opening, or slit, designated by numeral 6, is also formed in the hopper, and extends along a circular arc underlying the line along which the preforms are driven by the ring 3.

Such slit 6 is wider than the diameter of the body of the preform but smaller than its collar, so that the preform can take an essentially upright position.

With further reference to FIG. 2, in which the detail C of the end portion of the slit 6 is particularly shown, a preform exit conveyor 7 may be noticed.

Such conveyor 7 is placed at the end of the slit 6 at the same level as the perform exiting from the slit 6.

According to a first embodiment, the conveyor 7 is directly joined to the slit 6 so that the preform continues to follow its path onto such conveyor and the collar never falls out of its support guides whereas, in another embodiment, not shown, the conveyor 7 is separated from the slit 6 but at such a distance therefrom as to allow seamless passage of the preform from the slit 6 to the conveyor 7.

Preferably, the widths of the slit 6 and the conveyor 7 within which the body of the preform slides are substantially the same.

According to a further embodiment, not shown, a section is placed between the conveyor 7 and the slit 6 for joining such means 6 and 7, which may have a straight or curvilinear shape.

In other words, the axis of the exit conveyor 7 or the intermediate section, if any, is tangent and coincident with the axis of the slit 6, such axis being defined by the center line across the slit 6.

The exit conveyor 7 is and extends tangent to the preform exit point and comprises preform collar support and guide members.

Also, this conveyor 7 is straight or formed of a plurality of straight and/or curvilinear sections.

Both the guides 6A, 6B of the slit 6 and the guides 7A and 7B of the conveyor 7 may be adjusted in height and width by format change adjustment means, allowing to process preforms having different diameters.

Such format change is shown in FIGS. 3 and 4, which depict the A-A and B-B sections of FIG. 2 respectively and in which a knob 14 is shown to act on a bracket 15 connected to one of the guides 6B by one or more screws.

The other guide 6A is also connected to side wall 10 which delimits and retains the hopper.

The indentations 4 of the ring 3 preferably face the circular wall 10 of the hopper 2, to ensure that each preform is released from its housing 5 once it reaches the end portion of such housing.

1. An apparatus (1) for unscrambling and orientation of plastic preforms, said unscrambling being performed from an amount of preforms introduced in bulk in said apparatus (1), said orientation being designed to arrange such preforms in an essentially upright position, said preform comprising a collar of larger diameter than the body and said apparatus (1) being of the type comprising a circular hopper (2), a ring (3) concentric with said hopper (2), with a series of indentations (4) adapted to define a plurality of pockets or housings (5), which are in turn adapted to contain one preform at a time in an essentially horizontal position; a slit (6) extending along a circular arc underlying the line along which the preforms are driven by the ring (3), said slit being wider than the diameter of the body of the perform but smaller than its collar, so that the preform can take an essentially upright position; comprising a preform exit conveyor (7), characterized in that said conveyor (7) is placed at the end of the slit (6) at the same level as the perform exiting from the slit (6).

2. An apparatus (1) as claimed in claim 1, characterized in that the conveyor (7) is directly joined to the slit (6) so that the preform continues to follow its path onto such conveyor and the collar never falls out of its support guides.

3. An apparatus (1) as claimed in claim 1, characterized in that the conveyor (7) is separated from the slit but at such a distance therefrom as to allow seamless passage of the preform from the slit (6) to said conveyor (7).

4. An apparatus (1) as claimed in claim 1, characterized in that the indentations (4) of the ring (3) face the circular wall (10) of the hopper (2).

5. An apparatus as claimed in claim 1, characterized in that the widths of the slit (6) and the conveyor (7) within which the body of the preform slides are substantially the same.

6. An apparatus (1) as claimed in claim 1, characterized in that a section is placed between said conveyor (7) and said slit (6) for joining such means (6, 7); said section having either straight or curvilinear shape.

7. An apparatus (1) as claimed in claim 1, characterized in that the exit conveyor (7) is and extends tangent to the preform exit point.

8. An apparatus (1) as claimed in claim 1, characterized in that the exit conveyor (7) comprises preform collar support and guide members.

9. An apparatus (1) as claimed in claim 1, characterized in that the conveyor (7) is straight or formed of a plurality of straight and/or curvilinear sections.

10. An apparatus (1) as claimed in claim 1, characterized in that both the guides of the slit (6) and of the conveyor (7) may be adjusted in height and width by format change adjustment means, allowing to process preforms having different diameters.
